(19) United States
(12) Patent Application Publication
(10) Pub. No.: US 2010/0213188 A1
(43) Pub. Date: Aug. 26, 2010

(54) CERAMIC HEATER AND GLOW PLUG

(75) Inventors: Hiroshi Nishihara, Nagoya-shi (JP); Masahiro Konishi, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignee: NGK SPARK PLUG CO., LTD., Nagoya-shi ,Aichi (JP)

(21) Appl. No.: 12/160,487

(22) PCT Filed: Mar. 20, 2007
(86) PCT No.: PCT/JP2007/055753

§ 371 Date: Jul. 10, 2008

(30) Foreign Application Priority Data
Mar. 21, 2006 (JP) 2006-077860

(51) Int. Cl. H05B 3/18

(52) U.S. Cl. 219/544

(57) ABSTRACT

There are provided a ceramic heater in which a defect, such as generation of a gap at the interface between a heat-generating resistor and an insulating substrate, is unlikely to occur in the course of manufacture or use, and a glow plug using the ceramic heater. A ceramic heater 110 includes an insulating substrate 111 extending in the direction of an axis AX and a heat-generating resistor 115, which has a heat-generating portion 116, two lead portions 117, 117 and two lead lead-out portions 118a and 118b. The ceramic heater 110 satisfies an expression a≧0.15(b+c) in a section of the ceramic heater perpendicular to the direction of the axis AX, where a represents a minimum gap a between the pair of lead portions 117, 117 on the minimum-gap-associated imaginary straight line, and b and c represent dimensions of the pair of lead portions 117, 117.

### TECHNICAL FIELD

The present invention relates to a ceramic heater which is used in an ignition source such as a glow plug and to a glow plug using the ceramic heater.

### BACKGROUND ART

Regarding demand for glow plugs used to preheat diesel engines, recently, there has been increasing demand for glow plugs capable of quickly raising temperature. Glow plugs are required to exhibit, for example, such a temperature rise performance as to reach 1,000° C. in about two to three seconds at an applied voltage of 11 V. In order to satisfy such a requirement, in Patent Documents 1 to 3, for example, a silicon-nitride-tungsten-carbide composite sintered body, which is a conductive ceramic, is used to form a heat-generating resistor whose end portion (heat-generating portion) exhibits high resistance and whose lead portions exhibit low resistance.

Patent Document 1: Japanese Patent Application Laid-Open (kokai) No. 2002-203665
Patent Document 2: Japanese Patent Application Laid-Open (kokai) No. 2002-220285
Patent Document 3: Japanese Patent Application Laid-Open (kokai) No. 2002-289327

### DISCLOSURE OF THE INVENTION

### Problems to be Solved by the Invention

However, for example, when, as described in Patent Document 2, the tungsten carbide content of a silicon-nitride-tungsten-carbide composite sintered body is increased for lowering resistance, the thermal expansion coefficient of the heat-generating resistor formed from the silicon-nitride-tungsten-carbide composite sintered body also increases in proportion to the tungsten carbide content. This increases a difference in thermal expansion coefficient between the heat-generating resistor and an insulating substrate formed from a silicon nitride ceramic. As a result, in the course of manufacture or use, high thermal stress arises. This is apt to raise a defect, such as generation of a gap at the interface between the heat-generating resistor and the insulating substrate.

In order to achieve quick temperature rise, the heat-generating resistor has such a structure that a heat-generating portion located at its end is made thin, whereas its lead portions are made thick. Accordingly, high thermal stress is imposed on the large-diameter lead portions in the course of manufacture or use. This is apt to raise a defect, such as generation of a gap at the interface between the heat-generating resistor and the insulating substrate. In an all-ceramic heater whose lead portions are of a conductive ceramic, as compared with a heater which uses a tungsten lead wire, the overall length of the ceramic heater tends to increase. This is apt to increase thermal stress which is imposed on the ceramic heater in the course of manufacture or use. Accordingly, in such an all-ceramic heater, a defect, such as generation of a gap at the above-described interface is more likely to occur.

The present invention has been accomplished in view of the above-mentioned present situation, and an object of the invention is to provide a ceramic heater in which a defect, such as generation of a gap at the interface between a heat-generating resistor and an insulating substrate, is unlikely to occur in the course of manufacture or use, as well as a glow plug which uses the ceramic heater.

### Means for Solving the Problems

Means of solution is a ceramic heater extending in an axial direction and adapted to generate heat from its front end portion upon energization, the ceramic heater comprising an insulating substrate formed from an insulating ceramic and extending in the axial direction, and a heat-generating resistor formed from a conductive ceramic and embedded in the insulating substrate. In the ceramic heater, the heat-generating resistor comprises a heat-generating portion embedded in a front end portion of the insulating substrate, having such a form as to extend frontward from a rear side, change direction, and then again extend rearward, and generating heat upon energization; a pair of lead portions connected to respective rear ends of the heat-generating portion and extending rearward in the axial direction; and a pair of lead lead-out portions connected to the respective lead portions, extending radially outward, and exposed outward. The ceramic heater satisfies an expression a≧0.15(b+c) in any cross section of the ceramic heater which is taken perpendicular to the axial direction and in which the lead portions are present, where of imaginary straight lines which pass through the center of the cross section and along which a gap a between the lead portions is measured, an imaginary straight line associated with a minimum gap a is defined as a minimum-gap-associated imaginary straight line; and b and c are dimensions of the respective lead portions as measured on the minimum-gap-associated imaginary straight line.

As mentioned previously, an insulating ceramic and a conductive ceramic differ in thermal expansion coefficient; thus, thermal stress arises in the course of manufacture or use of a ceramic heater. This is apt to raise a defect, such as generation of a gap at the interface between the heat-generating resistor and the insulating substrate. Such a defect is apt to occur particularly at the interface between each of the paired lead portions and a portion of the insulating substrate intervening between the paired lead portions, for the following reason. Since the thermal expansion coefficient of the lead portions is greater than that of the insulating substrate, when temperature drops after firing or after use, the lead portions shrink to a greater extent than the insulating substrate. Conceivably, at that time, a portion of the insulating substrate intervening between the lead portions is pulled in opposite lateral directions by the lead portions; as a result, the portion is subjected to a greater stress than is the other portion.

By contrast, in the present invention, of imaginary straight lines which pass through the center of the cross section of the ceramic heater and along which a gap a between the lead portions is measured, an imaginary straight line associated with a minimum gap a is defined as the minimum-gap-associated imaginary straight line, and dimensions of the respective lead portions as measured on the minimum-gap-associated imaginary straight line are taken as b and c. The gap a is increased so as to satisfy the expression a≧0.15(b+c). Employment of the gap a between the lead portions which satisfies the relation reduces stress which is imposed on a portion of the insulating substrate intervening between the lead portions in the course of manufacture or use. Therefore, at the interface between each of the lead portions and a portion of the insulating substrate intervening between the lead portions, a defect, such as generation of a gap therebetween, becomes less likely to occur than in a conventional practice.

No particular limitation is imposed on the form of “a pair of lead portions,” so long as the lead portions are connected to respective rear ends of the heat-generating portion and extend rearward along the axial direction. However, preferably, as viewed in the cross section of the ceramic heater which is taken perpendicular to the axial direction, the lead portions are symmetrical to each other with respect to a straight line including the center of the ceramic heater (insulating substrate), while facing each other. This renders generated stress symmetrical, so that the ceramic heater becomes unlikely to suffer distortion or like deformation. Preferably, “a pair of lead portions” has such a shape that, in the cross section of the ceramic heater perpendicular to the axial direction, the dimensions b and c of the respective lead portions as measured on the minimum-gap-associated imaginary straight line are smaller than dimensions of the lead portions as measured along a direction perpendicular to the minimum-gap-associated imaginary straight line. Examples of a specific shape of the cross section of each of the lead portions which is taken perpendicular to the axial direction include elliptic and oblong shapes whose minor diameter corresponds to the dimension b or c, and a bow shape whose chord faces that of the other bow shape.

No particular limitation is imposed on the material for the “heat-generating resistor,” so long as a conductive ceramic is used. A typical conductive ceramic contains a conductive component and an insulating component. Examples of such a conductive component include a silicide, a carbide, and a nitride of one or more metal elements selected from among W, Ta, Nb, Ti, Mo, Zr, Hf, V, Cr, etc. An example of such an insulating component is silicon nitride.

No particular limitation is imposed on the material for the “insulating substrate,” so long as an insulating ceramic is used. A typical insulating ceramic is a silicon nitride sintered body. The silicon nitride sintered body may contain silicon nitride only or may contain a predominant amount of silicon nitride and a small amount of aluminum nitride, alumina, etc.

Another means of solution is a ceramic heater assuming the form of a cylindrical column extending in an axial direction and adapted to generate heat from its front end portion upon energization, comprising an insulating substrate formed from an insulating ceramic and assuming the form of a cylindrical column extending in the axial direction; and a heat-generating resistor formed from a conductive ceramic and embedded in the insulating substrate. The heat-generating resistor includes a heat-generating portion embedded in a front end portion of the insulating substrate, having such a form as to extend frontward from a rear side, change direction, and then again extend rearward, and generating heat upon energization; a pair of lead portions connected to respective rear ends of the heat-generating portion and extending rearward in the axial direction; and a pair of lead lead-out portions connected to the respective lead portions, extending radially outward, and exposed outward. The ceramic heater satisfies an expression 2≦D≦10 and an expression a ≦D−(b+c)−0.2 in any cross section of the ceramic heater which is taken perpendicular to the axial direction and in which the lead portions are present, where D (mm) is a diameter of the insulating substrate; of imaginary straight lines which pass through the center of the cross section and along which a gap a (mm) between the lead portions is measured, an imaginary straight line associated with a minimum gap a (mm) is defined as a minimum-gap-associated imaginary straight line; and b (mm) and c (mm) are dimensions of the respective lead portions as measured on the minimum-gap-associated imaginary straight line.

As mentioned previously, an insulating ceramic and a conductive ceramic differ in thermal expansion coefficient; thus, thermal stress arises in the course of manufacture or use of a ceramic heater. This is apt to raise a defect, such as generation of a gap between the heat-generating resistor and the insulating substrate. Such a defect is apt to occur also at the interface between each of the lead portions and a portion of the insulating substrate which is located radially outward of the lead portion and covers the lead portion. Therefore, portions of the insulating substrate which cover the respective lead portions from the radially outside of the lead portions must have a sufficient thickness to restrain occurrence of a defect such as crack. Specifically, in a ceramic heater whose insulating substrate has a diameter D of 2 mm to 10 mm, a portion of the insulating substrate located radially outward of each of the paired lead portions must have a thickness of 0.1 mm or greater (a total of both sides of 0.2 mm or greater).

By contrast, in the present invention, the diameter of the insulating substrate is taken as D (mm); of imaginary straight lines which pass through the center of the cross section of the ceramic heater and along which a gap a (mm) between the lead portions is measured, an imaginary straight line associated with a minimum gap a (mm) is defined as the minimum-gap-associated imaginary straight line; and dimensions of the respective lead portions as measured on the minimum-gap-associated imaginary straight line are taken as b (mm) and c (mm). The gap a is reduced so as to satisfy the expression a≦D−(b+c)−0.2. Through employment of the gap a between the lead portions satisfying the relation, the insulating substrate can be such that its portions located radially outward of the respective lead portions each have a thickness of 0.1 mm or greater (a total of 0.2 mm or greater). Therefore, in the course of manufacture or use, at the interfaces between the lead portions and the respective portions of the insulating substrate which cover the respective lead portions from the radially outside of the lead portions, a defect, such as generation of a gap therebetween, becomes less likely to occur than in a conventional practice.

Preferably, the ceramic heater mentioned above further satisfies an expression a≧0.15(b+c).

As mentioned previously, in the course of manufacture or use, also at the interface between each of the paired lead portions and a portion of the insulating substrate intervening between the paired lead portions, a defect, such as generation of a gap therebetween, is also apt to occur.

By contrast, in the present invention, the gap a between the lead portions is increased so as to satisfy the expression a≧0.15(b+c). Satisfaction of the relation lowers stress which is imposed on a portion of the insulating substrate intervening between the lead portions in the course of manufacture or use. Therefore, not only at the above-mentioned interface between each of the lead portions and a portion of the insulating substrate which covers the lead portion from the radially outside of the lead portion, but also at the interface between each of the lead portions and a portion of the insulating substrate intervening between the lead portions, a defect, such as generation of a gap, becomes less likely to occur than in a conventional practice.

Another means of solution is a glow plug comprising any one of the ceramic heaters mentioned above.

The glow plug of the present invention uses a ceramic heater in which a defect, such as generation of a gap at the interface between the insulating substrate and the lead portions, is unlikely to occur in the course of manufacture or use, and thus can exhibit high reliability.

### BRIEF DESCRIPTION OF THE DRAWINGS

FIG. 1 Longitudinal sectional view of a glow plug according to Embodiment 1.

FIG. 2 Longitudinal sectional view of a ceramic heater according to Embodiment 1.

FIG. 3 Cross-sectional view of the ceramic heater according to Embodiment 1 taken along line A-A of FIG. 2.

FIG. 4 Cross-sectional view of a ceramic heater according to Embodiment 2 corresponding to FIG. 3.

### DESCRIPTION OF REFERENCE NUMERALS

100, 200: glow plug
110, 210: ceramic heater
110s: front end portion (of ceramic heater)
110k: rear end portion (of ceramic heater)
111, 211: insulating substrate
111s: front end portion (of insulating substrate)
115: heat-generating resistor
116: heat-generating portion
116k: rear end (of heat-generating portion)
117, 217: lead portion
118a, 118b: lead lead-out portion
120: fixing tube
150: metallic shell
151: energization terminal
AX: axis
g: center
kl: minimum-gap-associated imaginary straight line
D: diameter of insulating substrate
a: gap between lead portions
b, c: dimension of lead portion along direction of juxtaposition of lead portions
d, e: thickness of portions of insulating substrate covering lead portions from radially outside

### BEST MODE FOR CARRYING OUT THE INVENTION

### Embodiment 1

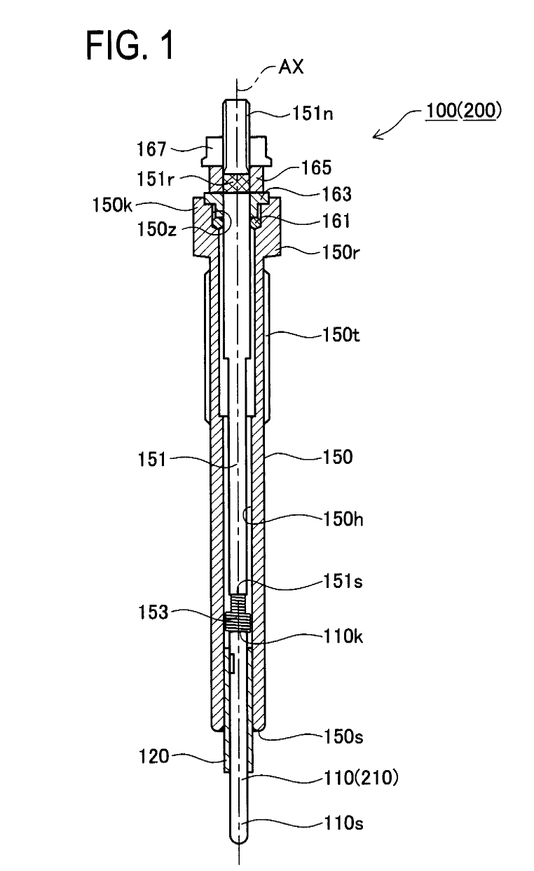

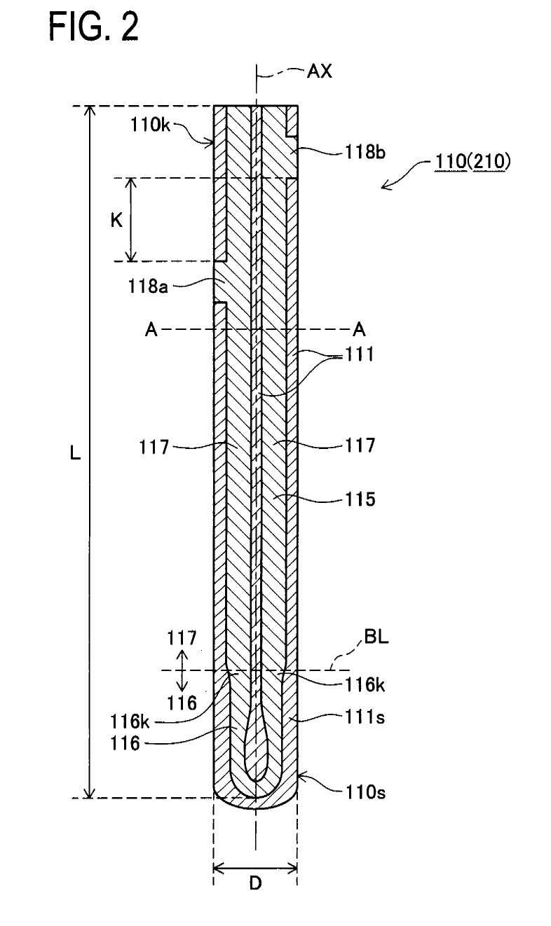

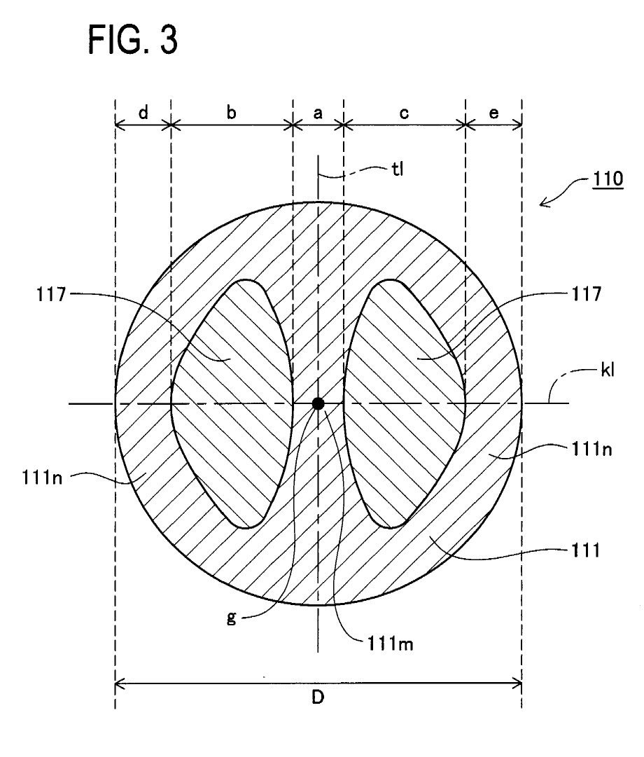

Embodiments of the present invention will next be described with reference to the drawings. FIG. 1 is a longitudinal sectional view of a glow plug 100 according to Embodiment 1. FIG. 2 is a longitudinal sectional view of a ceramic heater 110 according to Embodiment 1. FIG. 3 is a cross-sectional view of the ceramic heater 110 which is taken perpendicular to the direction of an axis AX (cross-sectional view taken along line A-A of FIG. 2).

The glow plug 100 includes a ceramic heater 110 formed from ceramic and extending in the direction of the axis AX, and a tubular metallic shell 150 which covers and holds a rear end portion of the ceramic heater 110. As will be described later, the ceramic heater 110 is designed such that, in the course of use, a defect, such as generation of a gap at the interface between a heat-generating resistor 115 and an insulating substrate 111 is unlikely to occur; therefore, the glow plug 100 exhibits high reliability.

The ceramic heater 110 is held in a through-hole 150h of the metallic shell 150 via a fixing tube 120 in such a manner that a front end portion 110s, which generates heat upon energization, projects from a front end portion 150s of the metallic shell 150. As shown in FIG. 2, the ceramic heater 110 has the insulating substrate 111 and the heat-generating resistor 115. The insulating substrate 111 extends in the direction of the axis AX and assumes a columnar form, and its front end (lower end in FIG. 2) is rounded to a hemispheric form. The heat-generating resistor 115 is embedded in the insulating substrate 111 along the direction of the axis AX.

The insulating substrate 111 is formed from a silicon nitride sintered body, which is an insulating ceramic, and has a diameter D of 3.3 mm and a length of 42 mm along the direction of the axis AX. The insulating substrate 111 has a thermal expansion coefficient of 3.2 ppm/° C. at room temperature.

The heat-generating resistor 115 is formed from a silicon-nitride-tungsten-carbide composite sintered body, which is a conductive ceramic, and includes a heat-generating portion 116, a pair of the lead portions 117, 117, and a pair of lead lead-out portions 118a, 118b. The heat-generating resistor 115 has an overall length L of 40.0 mm along the direction of the axis AX. Silicon nitride grains contained in the heat-generating resistor 115 have an average grain size of 0.6 μm. The heat-generating resistor 115 has a thermal expansion coefficient of 3.8 ppm/° C. at room temperature. Thus, the difference in thermal expansion coefficient at room temperature between the insulating substrate 111 and the heat-generating resistor 115 is 0.6 ppm/° C.

The heat-generating portion 116 is a portion on the front side (lower side) of a broken line BL in FIG. 2, and is embedded in a front end portion 111s of the insulating substrate 111. The heat-generating portion 116 has such a form as to extend frontward (downward in FIG. 2) from the rear side (upper side in FIG. 2), change direction, and then again extend rearward. When electricity is supplied to the heat-generating portion, it generates heat and its temperature becomes high. The heat-generating portion 116 is formed thinner than the lead portions 117, 117 so as to achieve high resistance.

The lead portions 117, 117 are continuous with the respective rear ends 116k, 116k of the heat-generating portion 116 and extend rearward in the direction of the axis AX while having the same thickness (same cross-sectional area). The lead portions 117, 117 are formed thicker than the heat-generating portion 116 so as to achieve low resistance. As is apparent from FIG. 3, which shows a cross section taken along line A-A of FIG. 2 (cross section perpendicular to the direction of the axis AX), the lead portions 117, 117 each also have a generally elliptical cross section and face each other symmetrically with respect to the imaginary straight line t1 including the center g of the ceramic heater 110 (the insulating substrate 111).

The ceramic heater 110 has an entire cross-sectional area Sa of 8.55 mm². The lead portions 117, 117 have a total cross-sectional area S1 of 1.68 mm². Of imaginary straight lines which pass through the center g of the cross section and along which a gap between the paired lead portions 117, 117 is measured, an imaginary straight line associated with a minimum gap is defined as a minimum-gap-associated imaginary straight line kl. As measured on the minimum-gap-associated imaginary straight line kl, the gap between the paired lead portions 117, 117 is taken as a, and dimensions of the paired lead portions 117, 117 are taken as b and c, respectively. In Embodiment 1, the gap a (the minimum thickness of a portion 111m of the insulating substrate 111 intervening between the lead portions 117, 117) is 0.43 mm (a=0.43 mm). The dimensions b and c of the respective lead portions 117, 117 are both 1.00 mm (b=c=1.00 mm). Portions 111n, 111n of the insulating substrate 111 which are located radially outward of and cover the respective lead portions 117, 117 have respective thicknesses d and e (as measured on the minimum-gap-associated imaginary straight line kl) of 0.435 mm (d=e=0.435 mm). Therefore, the ceramic heater 110 satisfies an expression a≧0.15(b+c). The ceramic heater 110 also satisfies an expression a≦D−(b+c)−0.2.

As mentioned previously, an insulating ceramic and a conductive ceramic differ in thermal expansion coefficient. Therefore, as a result of subjection to thermal stress in the course of manufacture or use of the ceramic heater 110, a defect, such as generation of a gap at the interface between the insulating substrate 111 and the heat-generating resistor 115, is apt to occur. Such a defect is particularly apt to occur at the interface between each of the lead portions 117, 117 and the portion 111m of the insulating substrate 111 intervening between the lead portions 117, 117.

However, in Embodiment 1, the gap a between the lead portions 117, 117 is increased so as to satisfy the expression a≧0.15(b+c). This lowers stress which is imposed on the portion 111m of the insulating substrate 111 intervening between the lead portions 117, 117, in the course of manufacture or use. Therefore, at the interface between each of the lead portions 117, 117 and the portion 111m of the insulating substrate 111 intervening between the lead portions 117, 117, a defect, such as generation of a gap therebetween, becomes less likely to occur than in a conventional practice.

As described above, a defect, such as generation of a gap between the heat-generating resistor 115 and the insulating resistor 111 is apt to occur also at the interfaces between the lead portions 117, 117 and the respective portions 111n, 111n of the insulating substrate 111 which are located radially outward of and cover the respective lead portions 117, 117. Therefore, the portions 111n, 111n of the insulating substrate 111 which cover the respective lead portions 117, 117 from the radially outside of the lead portions 117, 117 must have a sufficient thickness to restrain occurrence of a defect, such as generation of a gap.

By contrast, in Embodiment 1, the gap a between the lead portions 117, 117 is reduced so as to satisfy the expression a≦D−(b+c)−0.2. Through employment of the gap a satisfying the relation, the insulating substrate 111 can be such that its portions (111n) located radially outward of the respective lead portions 117, 117 each have a thickness of 0.1 mm or greater (specifically, 0.435 mm). Therefore, in the course of manufacture or use, at the interfaces between the lead portions 117, 117 and the respective portions 111n, 111n of the insulating substrate 111 which cover the respective lead portions 117, 117, a defect, such as generation of a gap therebetween, becomes less likely to occur than in a conventional practice.

The lead lead-out portions 118a, 118b are continuous with the respective lead portions 117, 117 and extend radially outward to be exposed outward. The lead lead-out portions 118a, 118b are arranged with a gap K of 5 mm or greater (5 mm in Embodiment 1) therebetween along the direction of the axis AX. The lead lead-out portion 118a located on the front side (lower side in FIGS. 1 and 2) is electrically connected to the metallic shell 150 via the fixing tube 120. The lead lead-out portion 118b located on the rear side (upper side in FIGS. 1 and 2) is electrically connected to an energization terminal 151 via a lead coil 153, as will be described later.

### Examples

In order to verify the effect of Embodiment 1, nine kinds of ceramic heaters 110 were manufactured as Examples 1 to 9 according to the present invention while the total cross-sectional area S1 of the lead portions 117, 117, the gap a between the lead portions 117, 117, and the lateral dimensions b and c (along the direction of juxtaposition) of the respective lead portions 117, 117 were varied. Specifically, as shown in Table 1, the total cross-sectional area S1 of the lead portions 117, 117 was set to 0.30 Sa or 0.34Sa. The gap a between the lead portions 117, 117 was set to 0.15 mm, 0.20 mm, 0.29 mm, 0.70 mm, 1.00 mm, 1.20 mm, 1.25 mm, or 1.50 mm. The lateral dimensions (along the direction of juxtaposition) b and c of the respective lead portions 117, 117 were set to 0.82 mm (b+c=1.64 mm) or 0.94 mm (b+c=1.88 mm).

Meanwhile, as a comparative example, there was prepared a ceramic heater manufactured such that the total cross-sectional area S1 of the lead portions 117, 117 was 0.34 Sa, the gap a between the lead portions 117, 117 was 0.25 mm, and the lateral dimensions (along the direction of juxtaposition) b and c of the respective lead portions 117, 117 was 0.94 mm (b+c=1.88 mm).

Notably, the cross-sectional area Sa of each ceramic heaters 110 was set to 8.55 mm² as in the case of Embodiment 1 described above, and the diameter D was set to 3.30 mm as in the case of Embodiment 1 described above.

The ceramic heaters 110 were measured for residual stress. Specifically, the residual stress was obtained from toughness which was measured at a cut position by the method specified in JIS R1607 “Testing Method for Fracture toughness of Fine Ceramics.” Measured values of toughness were converted to values of residual stress by FEM analysis.

Also, the ceramic heaters 110 were measured for flexural strength. Specifically, the flexural strength was measured by the following flexural-strength measuring method in accordance with JIS R1601. Each of the ceramic heaters 110 was supported at opposite sides of the center of the ceramic heater 110 along the direction of the axis AX (span: 12 mm), and load was applied to the center of the ceramic heater 110 at a crosshead-moving speed of 0.5 mm/min.

Moreover, the ceramic heaters 110 were subjected to a service durability test. Specifically, the service durability test was conducted as follows. A DC power source was connected to the ceramic heater 110, and voltage was adjusted such that the surface temperature of the ceramic heaters 110 reaches 1,450° C. in two seconds in an environment of room temperature. Each of the ceramic heaters 110 was heated through application of the voltage and was subsequently air-cooled for 30 seconds so as to be cooled to room temperature. With this procedure taken as one cycle, the number of cycles until the heat-generating resistor 115 fractured was measured.

TABLE 1

| | Cross- | | | | | | | |
|---|---|---|---|---|---|---|---|---|
| | sectional | | | | | Residual | Flexural | Service |
| | area | a | b + c | a ≧ | a ≦ D − | stress | strength | durability |
| | S1 | (mm) | (mm) | 0.15(b + c) | (b + c) − 0.2 | (MPa) | (MPa) | (cycles) |
| Ex. 1 | 0.30Sa | 0.20 | 1.64 | X | ◯ | 180 | 1,005 | 16,158 |
| Ex. 2 | 0.30Sa | 1.00 | 1.64 | ◯ | ◯ | 153 | 986 | 19,503 |
| Ex. 3 | 0.30Sa | 1.50 | 1.64 | ◯ | X | 125 | 692 | 35,562 |
| Ex. 4 | 0.34Sa | 0.15 | 1.88 | X | ◯ | 225 | 1,255 | 12,501 |
| Ex. 5 | 0.34Sa | 0.20 | 1.88 | X | ◯ | 215 | 1,165 | 13,369 |
| Ex. 6 | 0.34Sa | 0.29 | 1.88 | ◯ | ◯ | 200 | 1,265 | 14,005 |
| Ex. 7 | 0.34Sa | 0.70 | 1.88 | ◯ | ◯ | 185 | 1,045 | 15,050 |
| Ex. 8 | 0.34Sa | 1.20 | 1.88 | ◯ | ◯ | 160 | 1,036 | 17,503 |
| Ex. 9 | 0.34Sa | 1.25 | 1.88 | ◯ | X | 155 | 756 | 18,569 |
| Comp. | 0.34Sa | 0.25 | 1.88 | X | X | 270 | 530 | 30 |
| Ex. | | | | | | | | |

As is apparent from Table 1, of Examples 1 to 3 having a total cross-sectional area S1 of the lead portions 117, 117 of 0.30 Sa, Examples 2 and 3 which satisfies a ≧0.15(b+c) (marked with “O” in Table 1) exhibited the effect of effectively lowering residual stress. Further, in the service durability test, Examples 2 and 3 exhibited good service durabilities of 19,503 cycles and 35,562 cycles, respectively. Conceivably, this result is caused by the fact that the cross-sectional area S1 is smaller than those of other Examples.

Example 1 having a distance a of 0.20 mm involved no problem in terms of a completed product as a ceramic heater 110. However, Example 1 may involve the following problems. Burrs which are generated in a process of injection-molding the heat-generating resistor 115 may cause a short circuit. Since a process of removing the burrs requires accurate working, yield may drop.

Examples 1 and 2 which satisfy a≦D−(b+c)−0.2 (marked with “O” in Table 1) exhibited a good flexural strength of 1,005 MPa and 986 MPa, respectively.

Example 3 having a distance a of 1.50 mm exhibited high service durability stemming from lowering of residual stress, but exhibited a rather low flexural strength not higher than 800 MPa; specifically, 692 MPa. Service durability and flexural strength are in a trade-off relation with each other. Example 2 implements high service durability and high flexural strength.

Next, Examples 4 to 9 having a cross-sectional area S1 of 0.34 Sa will be described. These Examples also show a tendency similar to that of Examples 1 to 3 having a cross-sectional area S1 of 0.30 Sa. Specifically, Examples 4 and 5 which do not satisfy a≧0.15(b+c) are high in residual stress and low in service durability in relation to other Examples, but exhibits high flexural strength.

By contrast, Example 9 which does not satisfy a≦D−(b+c)−0.2 can lower residual stress, and exhibits excellent service durability in spite of a relatively large cross-sectional area S1; however, Example 9 exhibits a rather low flexural strength not higher than 800 MPa; specifically, 756 MPa, as in the previously described case. Examples 6 to 8 implement high service durability and high flexural strength.

Unlike these Examples 1 to 9, Comparative Example, which satisfies neither a≧0.15(b+c) nor a≦D−(b+c)−0.2 is high in residual stress (270 MPa), and exhibits extremely low service durability (30 cycles) and low flexural strength (530 MPa).

These results show that a ceramic heater which is excellent in terms of durability, etc. can be obtained when either one (preferably, both) of the expressions a≧0.15(b+c) and a≦D−(b+c)−0.2 are satisfied.

Next, other members of the glow plug 100 will be described (see FIG. 1). The fixing tube 120 is attached to an outer circumference of the ceramic heater 110 and is fixed by means of a brazing material. The fixing tube 120 is inserted into the through-hole 150h of the metallic shell 150 and is fixed by means of a brazing material.

The rodlike energization terminal 151 extends through the tubular metallic shell 150. A front end portion 151s of the energization terminal 151 and a rear end portion 110k of the above-described ceramic heater 110 are electrically connected together via the lead coil 153. Specifically, the lead coil 153 is wound onto and welded to the front end portion 151 of the energization terminal 151, and is wound onto and welded to the rear end portion 110k of the ceramic heater 110 while being in contact with the lead lead-out portion 118b (see FIG. 2) located at the rear end portion 110k. A rear portion of the energization terminal 151 extends through the metallic shell 150 and projects rearward (upward in FIG. 1) from the rear end portion 150k of the metallic shell 150. The projecting portion of the energization terminal 151 is externally threaded, thereby forming an externally threaded portion 151n.

The rear end portion 150k of the metallic shell 150 is formed into a tool engagement portion 150r which has a hexagonal cross section and with which a tool, such as a torque wrench, is engaged when the glow plug 100 is attached to a diesel engine. A portion of the metallic shell 150 which is located immediately frontward of the tool engagement portion 150r is formed into a mounting threaded portion 150t. The rear end portion 150k of the metallic shell 150 has a counter sunk portion 150z formed at a portion of the through-hole 150h associated with the rear end portion 150k. An O-ring 161 made of rubber and an insulating bush 163 made of nylon which are fitted to the energization terminal 151 are fitted into the counter sunk portion 150z. A press ring 165 is fitted to the energization terminal 151 at a position located rearward of the insulating bush 163 so as to prevent detachment of the insulating bush 163. The press ring 165 is crimped onto the outer circumference of the energization terminal 151, thereby being fixed onto the energization terminal 151. In order to enhance crimp-bonding force, a portion of the energization terminal 151 corresponding to the press ring 165 is knurled on its outer circumferential surface, thereby forming a knurled portion 151r. A nut 167 is threadingly engaged with the energization terminal 151 at a position located rearward of the press ring 165. The nut 167 is adapted to fix an unillustrated energization cable to the energization terminal 151.

The thus-configured glow plug 100 is attached to a mounting hole formed in a cylinder head of an unillustrated diesel engine through utilization of the mounting threaded portion 150t of the metallic shell 150. This disposes the front end portion 110s of the ceramic heater 110 within a combustion chamber of the engine. In this state, when voltage is applied to the energization terminal 151 from a battery equipped in a vehicle, current flows from the energization terminal 151 through the lead coil 153, one lead lead-out portion 118b, one lead portion 117, the heat-generating portion 116, the other lead portion 117, the other lead lead-out portion 118a, and the metallic shell 150. This causes the front end portion 110s of the ceramic heater 110 in which the heat-generating portion 116 is present, to quickly increase in temperature. In a state in which a front end portion of the ceramic heater 110 is heated to a predetermined temperature, fuel is sprayed from an unillustrated fuel spray system. Thus, ignition of fuel is assisted, and fuel burns, thereby starting the diesel engine.

The ceramic heater 110 and the glow plug 100 described above can be manufactured by respectively known methods.

The ceramic heater 110 is manufactured as follows. 10 Parts by mass Yb₂O₃ powder and 2 parts by mass SiO₂ powder are added, as sintering aid, to 88 parts by mass silicon nitride material powder, thereby yielding an insulating-component material. 40% By mass insulating-component material and 60% by mass WC powder, which is a conductive ceramic, are wet-mixed for 72 hours. The resultant mixture is dried, thereby yielding a mixture powder. Subsequently, the mixture powder and a binder are placed in a kneader and are then kneaded for four hours. Next, the resultant kneaded substance is cut into pellets. The thus-obtained pellets of the kneaded substance are charged into an injection molding machine, followed by injection into an injection molding mold having a U-shaped cavity corresponding to the heat-generating resistor 115. Thus is yielded a green heat-generating resistor of a conductive ceramic.

11 Parts by mass Yb₂O₃ powder, 3 parts by mass SiO₂ powder, and 5 parts by mass MoSi₂ powder are added, as sintering aid, to 86 parts by mass silicon-nitride material powder. The resultant mixture is wet-mixed for 40 hours. The resultant mixture is spray-dried, thereby yielding a powder. The thus-obtained powder is compacted into two green halves. The two green halves correspond in shape to two halves obtained by halving the completed insulating substrate 111 along the axis AX. Each of the two green halves has a recess corresponding in shape to the above-mentioned green heat-generating resistor in the parting face of the green half. The green heat-generating resistor is sandwiched between the two green halves while being fitted into the recesses. The resultant assembly is pressed into a single piece, thereby yielding a green ceramic heater.

Next, the green ceramic heater is preliminarily fired at 600° C. in a nitrogen atmosphere so as to remove binder and the like from the injection-molded green heat-generating resistor and from the green insulating substrate, thereby yielding a preliminarily fired body. Subsequently, the preliminarily fired body is set in a press die made of graphite and is then hot-press-fired at 1,800° C. under a pressure of 29.4 MPa in a nitrogen atmosphere for 1.5 hour, thereby yielding a fired body. The surface (outer surface) of the fired body is subjected to centerless polishing, thereby completing the ceramic heater 110.

The glow plug 100 is manufactured in the following manner. First, the above-mentioned ceramic heater 110 and the energization terminal 151 are connected together via the lead coil 153. The fixing tube 120 is attached to the ceramic heater 110, and then the fixing tube 120 and the ceramic heater 110 are fixed together by means of a brazing material. Subsequently, the metallic shell 150 is prepared. An assembly of the ceramic heater 110, the energization terminal 151, and the fixing tube 110 is inserted into the through-hole 105h of the metallic shell 150. Then, the metallic shell 150 and the fixing tube 120 are fixed together by means of a brazing material. Subsequently, the O-ring 161 is fitted into the counter sunk portion 150z formed in the rear end portion 150k of the metallic shell 150, and then the insulating bush 163 is fitted into the counter sunk portion 150z. Then, the press ring 165 is attached by crimping. The nut 167 is fixed at a predetermined position, thereby completing the glow plug 100.

### Embodiment 2

Next, Embodiment 2 will be described. Description of features similar to those of Embodiment 1 described above is omitted or briefed. A ceramic heater 210 and a glow plug 200 of Embodiment 2 differ from the ceramic heater 110 and the glow plug 100 of Embodiment 1 described above in the form of arrangement of a pair of lead portions 217, 217 embedded in an insulating substrate 211. Other structural features are similar to those of Embodiment 1 described above and are therefore denoted by like reference numerals, and description thereof is omitted or briefed.

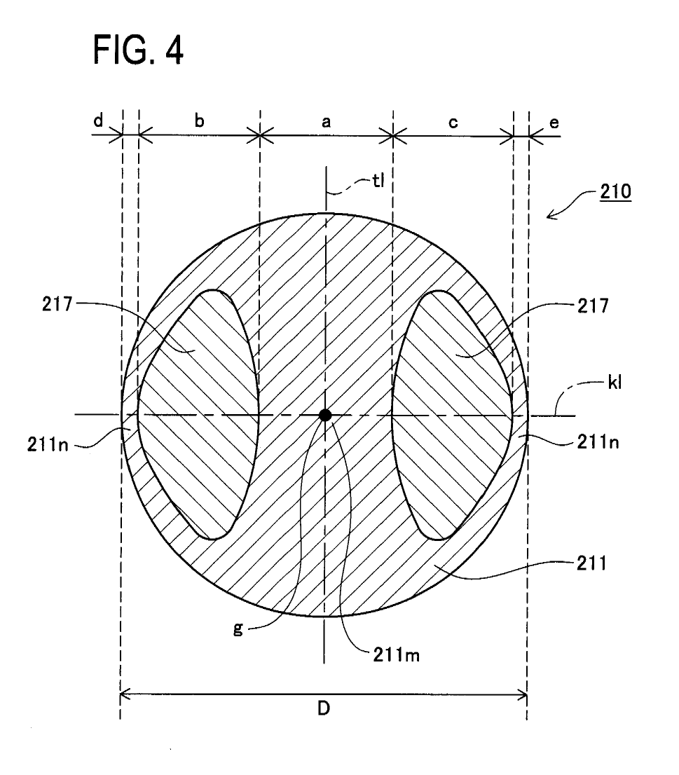

FIG. 4 is a cross-sectional view of the ceramic heater 210 (equivalent of FIG. 3 showing Embodiment 1). In Embodiment 2, the lead portions 217, 217 each also have a generally elliptical cross section, and face each other symmetrically with respect to a straight line (not shown) including a center g of the insulating substrate 211.

In the cross section of the ceramic heater 210, of imaginary straight lines which pass through the center g of the cross section and along which a gap between the paired lead portions 217, 217 is measured, an imaginary straight line associated with a minimum gap is defined as a minimum-gap-associated imaginary straight line kl. As measured on the minimum-gap-associated imaginary straight line kl, the gap between the paired lead portions 217, 217 is taken as a, and dimensions of the paired lead portions 217, 217 are taken as b and c, respectively. The gap a (the minimum thickness of a portion 211m of the insulating substrate 211 intervening between the lead portions 217, 217) is 1.1 mm (a=1.1 mm). The dimensions b and c of the respective lead portions 217, 217 are both 1.0 mm (b=c=1.0 mm). Portions 211n, 211n of the insulating substrate 211 which are located radially outward of and cover the respective lead portions 217, 217 have respective thicknesses d and e (as measured on the minimum-gap-associated imaginary straight line kl) of 0.1 mm (d=e=0.1 mm). Therefore, the ceramic heater 210 also satisfies the expression a≧0.15(b+c). The ceramic heater 210 also satisfies the expression a≦D−(b+c)−0.2.

As mentioned above, also in Embodiment 2, the gap a between the lead portions 217, 217 is increased so as to satisfy the expression a≧0.15(b+c). This lowers stress which is imposed on the portion 211m of the insulating substrate 211 intervening between the lead portions 217, 217, in the course of manufacture or use. Therefore, at the interface between each of the lead portions 217, 217 and the portion 211m of the insulating substrate 211 intervening between the lead portions 217, 217, a defect, such as generation of a gap therebetween, becomes less likely than in a conventional practice.

Furthermore, the gap a between the lead portions 217, 217 is reduced so as to satisfy the expression a≦D−(b+c)−0.2. Therefore, the insulating substrate 211 can be such that its portions (211n) located radially outward of the respective lead portions 217, 217 each have a thickness of 0.1 mm or greater (in Embodiment 2, 0.1 mm). Therefore, in the course of manufacture or use, of the insulating substrate 211, the lead portions 217, l . Other features similar to those of Embodiment 1 described above provide similar actions and effects as do the similar features of Embodiment 1.

While the present invention has been described with reference to above Embodiments 1 and 2, the present invention is not limited thereto, but may be modified as appropriate without departing from the spirit or scope of the invention.

1. A ceramic heater extending in an axial direction and adapted to generate heat from its front end portion upon energization, comprising:
an insulating substrate formed from an insulating ceramic and extending in the axial direction; and
a heat-generating resistor formed from a conductive ceramic and embedded in the insulating substrate, wherein the heat-generating resistor includes:
a heat-generating portion embedded in a front end portion of the insulating substrate, having such a form as to extend frontward from a rear side, change direction, and then again extend rearward, and generating heat upon energization,
a pair of lead portions connected to respective rear ends of the heat-generating portion and extending rearward in the axial direction, and
a pair of lead lead-out portions connected to the respective lead portions, extending radially outward, and exposed outward; and
the ceramic heater satisfies an expression a≧0.15(b+c) in any cross section of the ceramic heater which is taken perpendicular to the axial direction and in which the lead portions are present, where:
of imaginary straight lines which pass through the center of the cross section and along which a gap a between the lead portions is measured, an imaginary straight line associated with a minimum gap a is defined as a minimum-gap-associated imaginary straight line; and
b and c are dimensions of the respective lead portions as measured on the minimum-gap-associated imaginary straight line.

2. A ceramic heater assuming the form of a cylindrical column extending in an axial direction and adapted to generate heat from its front end portion upon energization, comprising:
an insulating substrate formed from an insulating ceramic and assuming the form of a cylindrical column extending in the axial direction; and
a heat-generating resistor formed from a conductive ceramic and embedded in the insulating substrate, wherein the heat-generating resistor includes:
a heat-generating portion embedded in a front end portion of the insulating substrate, having such a form as to extend frontward from a rear side, change direction, and then again extend rearward, and generating heat upon energization,
a pair of lead portions connected to respective rear ends of the heat-generating portion and extending rearward in the axial direction, and
a pair of lead lead-out portions connected to the respective lead portions, extending radially outward, and exposed outward; and
the ceramic heater satisfies an expression 2≦D≦10 and an expression a≦D−(b+c)−0.2 in any cross section of the ceramic heater which is taken perpendicular to the axial direction and in which the lead portions are present, where:
D (mm) is a diameter of the insulating substrate;
of imaginary straight lines which pass through the center of the cross section and along which a gap a (mm) between the lead portions is measured, an imaginary straight line associated with a minimum gap a (mm) is defined as a minimum-gap-associated imaginary straight line; and
b (mm) and c (mm) are dimensions of the respective lead portions as measured on the minimum-gap-associated imaginary straight line.

3. A ceramic heater according to claim 2, further satisfying an expression a≧0.15(b+c).

4. A glow plug comprising a ceramic heater according to claim 1.

5. A glow plug comprising a ceramic heater according to claim 2.
